(19) United States
(12) Patent Application Publication
(10) Pub. No.: US 2020/0013061 A1
(43) Pub. Date: Jan. 9, 2020

(54) SYSTEM AND METHOD FOR MEASURING USER BEHAVIOR CONSISTENCY BASED ON COMPLEX CORRESPONDENCE SYSTEM

(71) Applicant: TONGJI University, Shanghai (CN)

(72) Inventors: Changjun JIANG, Shanghai (CN); Hongzhong CHEN, Shanghai (CN); Chungang YAN, Shanghai (CN); Zhijun DING, Shanghai (CN); Mimi WANG, Shanghai (CN); Peihai ZHAO, Shanghai (CN)

(21) Appl. No.: 16/027,176

(22) Filed: Jul. 3, 2018

(51) Int. Cl. G06Q 20/40; H04L 29/06; G06F 16/23; G06F 16/28

(52) U.S. Cl. CPC G06Q 20/4014; G06F 16/285; G06F 16/2365; H04L 63/1425

(57) ABSTRACT

System and methods for performing behavior consistency verification are described. The method may include receiving user behavior data containing user activities performed during electronic transactions. The method may include retrieving expected behavior data corresponding to the user behavior data. The method may include generating a behavior consistency measurement based on the user behavior data and the expected behavior data. The method may further include transmitting the behavior consistency measurement in response to the receiving of the user behavior data. The behavior consistency measurement indicates a degree of consistency between the user behavior data and the expected behavior data.

### CROSS-REFERENCE

This is a continuation-in-part application based on a pending U.S. patent application Ser. No. 15/325,184, filed on Jan. 10, 2017, which claims priority to a PCT Application No. PCT/CN2014/095859, filed on Dec. 31, 2014, both of which are hereby incorporated by reference in their entireties, including any appendices or attachments thereof, for all purposes.

### TECHNICAL FIELD

The present disclosure relates to system and method to measure user behavior consistency for securing Internet transactions and online payments.

### BACKGROUND

In recent years, e-commerce and online payment transactions have become increasingly popular. However, potential hazards due to malicious behaviors such as frauds and hacking are threatening the credibility of these electronic transactions. These malicious behaviors are not consistent with normal user behaviors and habits, and detecting such behavior inconsistencies in order to prevent abnormal infringements in electronic transactions is greatly needed.

Since system designers and data modelers may hold different points of view with respect to the same real world phenomenon, various models may be established for the real world phenomenon. Consequently, consistency among various models may be determined by matching the semantics of the elements in these models using model-matching techniques. However, according to statistics, when evaluating the correspondences among different models, more than 40% of them may be deemed complex correspondences, and more than 7% may be deemed cross-repetitive correspondences. How to perform consistency analysis between user behaviors and expected behaviors in electronic transactions may have a critical significance for modeling complex systems.

In the past, some researches were conducted to evaluate consistency between two models (i.e., a user behavior model and an expected model) by using measurement methods such as trace matching, mutual simulation, and behavior profiling. However, these methods cannot effectively distinguish situations in complex correspondences among behaviors, and cannot produce accurate calculations quickly.

### SUMMARY

The purpose of the present disclosure is to measure behavior consistency between a user behavior model and an expected model, perform specific classified analysis based on complex correspondence behavior relations, and determine behavior correspondence characteristics of all complex classes. Further, the present disclosure may generate a measurement of behavior consistency containing cross repetitive correspondence, by calculating behavior consistency among models using knowledge related to matrixes and measuring a compliance degree of behavior consistency containing complex correspondence relations.

### BRIEF DESCRIPTION OF THE DRAWINGS

To clarify the present disclosure, the accompanying drawings for the various embodiments are briefly described below.

FIG. 1 illustrates a block diagram of a behavior verification environment that provides user behavior consistency evaluations;

FIG. 2 illustrates a process performed by a behavior verification system for measuring a degree of user behavior consistency;

FIG. 2-A to FIG. 2-F illustrate multiple examples of behavior relation matrixes;

FIG. 3 illustrates a process to generate behavior relation matrix and behavior relation matrix graph;

FIG. 4 illustrates a process to obtain a behavior consistency measurement;

FIG. 5 illustrates an exemplary list of workflow nets, according to certain embodiments of the present disclosure;

FIG. 6-A illustrates an exemplary list of behavior relation matrix graphs;

FIG. 6-B illustrates an exemplary list of decomposed behavior relation matrix graphs; all arranged in accordance with certain embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated herein.

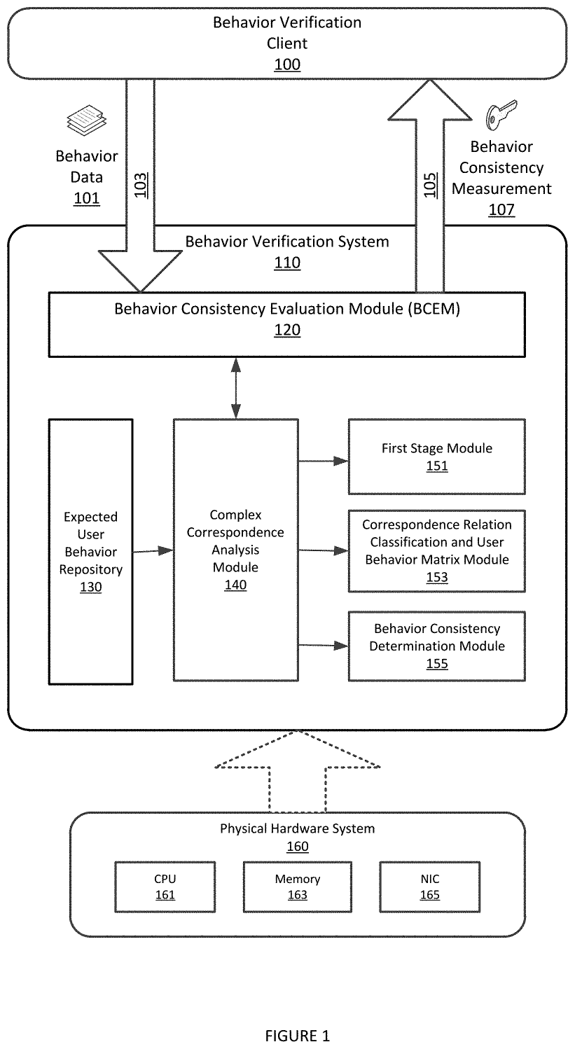

FIG. 1 illustrates a block diagram of a behavior verification environment that provides user behavior consistency evaluations, according to one or more embodiments of the present disclosure. In FIG. 1, a behavior verification client 100 may interact with a behavior verification system 110 to perform user behavior verification during electronic transactions. In some embodiments, the behavior verification client 100 may be a web-based software module or hardware module interacting with the behavior verification system 110 via Internet network communication protocols such as Hypertext Transfer Protocol (HTTP). The behavior verification client 100 may also be a software application installed on a remote networked computer and interacting with the behavior verification system 110 via Transmission Control Protocol/Internet Protocol (TCP/IP) communications.

In some embodiments, the behavior verification client 100 may be accessed by one or more users during electronic transactions such as online payments or user authentications. The behavior verification client 100 may monitor these users' behaviors during such electronic transactions. Examples of monitored user behaviors may include electronic/online user actions/activities such as data inputting (e.g., inputting user names and passwords), web-page accessing (e.g., accessing specific secured web sites), web-browsing patterns, payment transactions, data updating actions (e.g., updating personal credentials), etc. The behavior verification client 100 may collect these monitored user behaviors as user behavior data 101, embedded such user behavior data 101 in a request message, and transmit (103) the request message to the behavior verification system 110 for user behavior consistency evaluation and behavior verification.

In some embodiments, the behavior verification system 110, which may be constructed based on a physical hardware system 160, may include, without limitation, a behavior consistency evaluation module (BCEM) 120, an expected user behavior repository 130, and a complex correspondence analysis module 140. The BCEM 120 may be configured to receive (103) behavior data 101 from the behavior verification client 100, and invoke multiple internal modules (e.g., module 140) to perform behavior consistency verification based on expected behavior data. Specifically, the “expected behavior data” may include historical and typical user behavior data that were previously collected from trustworthy users, and have been validated as being less likely to be associated with fraudulent behaviors.

In some embodiments, the BCEM 120 may generate a behavior consistency measurement 107, embed the behavior consistency measurement 107 in a response message, and transmit (105) the response message back to the behavior verification client 100 in response to the previously received request message. Specifically, the “behavior consistency measurement” may be a value (e.g., a degree value within a specific range, or a percentage value) that can be used to quantify the consistency between the behavior data 101 and the expected behavior data. In other words, the behavior consistency measurement 107 may be used to describe whether the received behavior data 101 is consistent in view of the expected behavior data. A lower behavior consistency measurement may indicate that the behavior data 101 is inconsistent with the historical expected behavior data, is less trustworthy and possibly coming from unauthorized user, thereby indicating fraudulent and suspicious situations. A higher behavior consistency measurement may show that the behavior data 101 is more likely generated by authenticated user, and can be relied upon.

In some embodiments, the BCEM 120 may utilize the complex correspondence analysis module 140 to perform a complex analysis of the inner behavior relations associated with user behavior data 101, establish behavior relations profiles and classify complex correspondence relations, and calculate user behavior consistency measurement 107 based on the complex correspondence relations. The complex correspondence analysis module 140 may retrieve, from the expected user behavior repository 130, expected user behavior data that is associated with the received behavior data 101. The complex correspondence analysis module 140 may then utilize a first-stage module 151, a second-stage module 153, and a third-stage module 155 to perform the detail classification and calculation operations mentioned above. The details about the first-stage module 151, the second-stage module 153, and the third-stage module 155 are further described below.

In some embodiments, the expected user behavior repository 130 may be a data storage module configured for storing expected behavior data. In some embodiments, the expected user behavior repository 130 may be a storage medium (e.g., memory or hard drive) or a database located within the behavior verification system 110. Alternatively, the expected user behavior repository 130 may also be a remote data storage service (e.g., a data cloud) that can provide expected behavior data via network communications.

It should be recognized that the various terms, layers and categorizations used to describe the components in FIG. 1 may be referred to differently without departing from their functionalities or the spirit and scope of the present disclosure. For example, the BCEM 120 and the complex correspondence analysis module 140 may be located in the same physical hardware system 160, while the expected user behavior repository 130 may be deployed on another physical hardware system 160.

In some embodiments, the physical hardware system 160 may be configured with, without limitation, a Central Processing Unit (CPU) 161, memory 163, a Network Interface Card (NIC) 165, and/or additional electronic circuit components not shown in FIG. 1. The CPU 161 may be a general-purpose or specialized computing processor having electronic circuitry to perform arithmetical, logical, and input/output operations for the physical hardware system 160. The CPU 161 may be configured to accelerate the accessing of the expected user behavior repository 130. The CPU 161 may be configured to support functions of the BCEM 120. The CPU 161 may also be configured to utilize the physical memory 163 to store or retrieve behavior relation matrixes and graphs. The memory 163 may be hardware storage devices having integrated circuits for storing information used in the behavior verification system 110. The memory 163 may be volatile memory (e.g., dynamic random-access memory (DRAM) or CPU cache memory) and non-volatile memory (e.g., hard drive or flash memory). In some embodiments, the memory 163 may be non-transitory computer-readable storage medium, containing a set of instructions which, when executed by the CPU 161, cause the CPU 161 to perform a method of behavior consistency verification. The NIC 165 may be network communication hardware for transmitting messages among the various components (e.g., the BCEM 120 and the complex correspondence analysis module 140) within, or delivering messages in and out of, the behavior verification system 110. In some embodiments, the behavior verification system 110 may be implemented in a distributed virtualized environment (e.g., using virtualization applications such as VMWARE® vCenter).

Thus, the behavior verification system 110 may effectively distinguish the complex correspondence relations between the behavior data 101 and the expected behavior data, and accordingly make a more accurate judgment of the behavior consistency based on the behavior correspondence relations. Specifically, the behavior verification system 110 may use a behavior profile technique to quantify user behavior consistency. The behavior verification system 110 may generate a set of behavior relation matrixes to model the behavior data, the expected user behavior data, and the behavior relations among these behavior data. Further, the behavior verification system 110 may also distinguish the cross-repetitive correspondence situations, and greatly improve the accuracy and the time in generating the behavior consistency measurement.

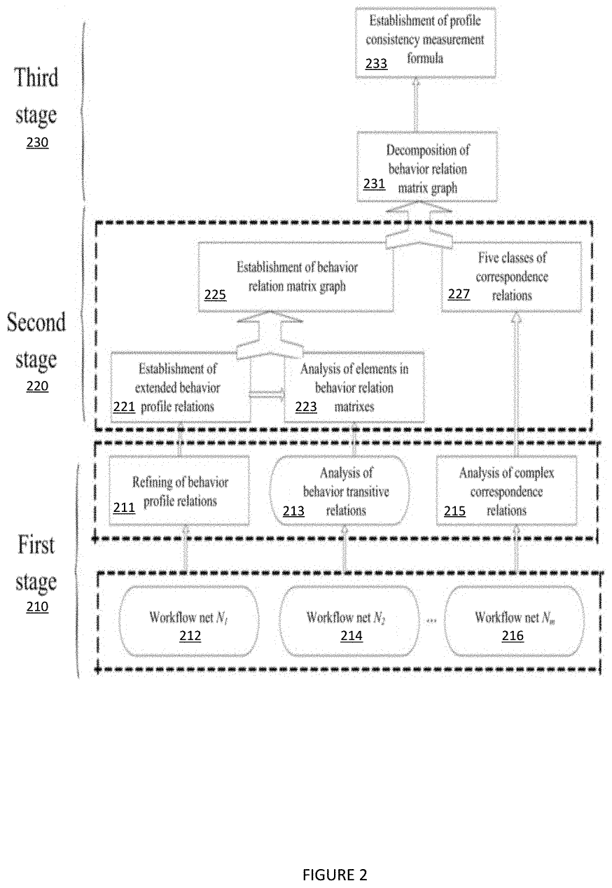

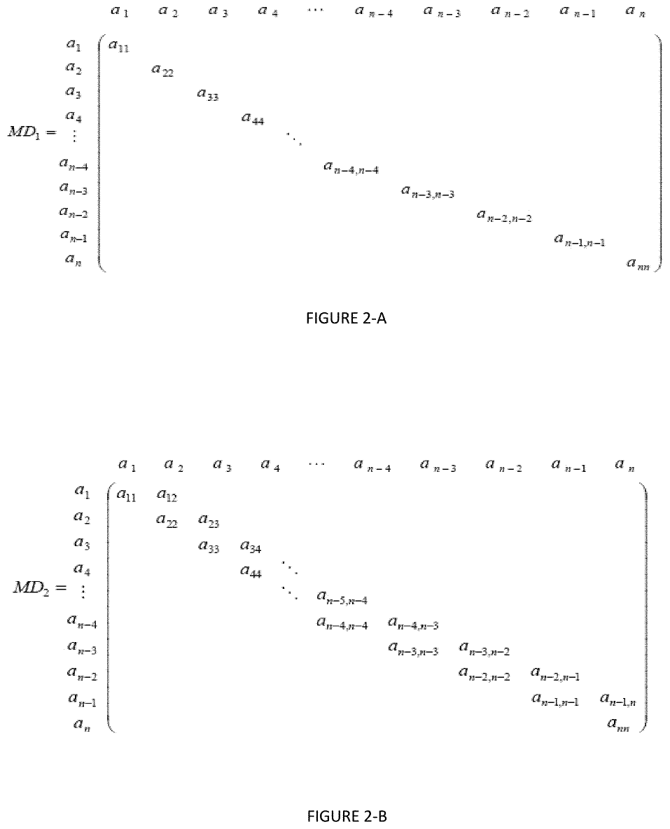

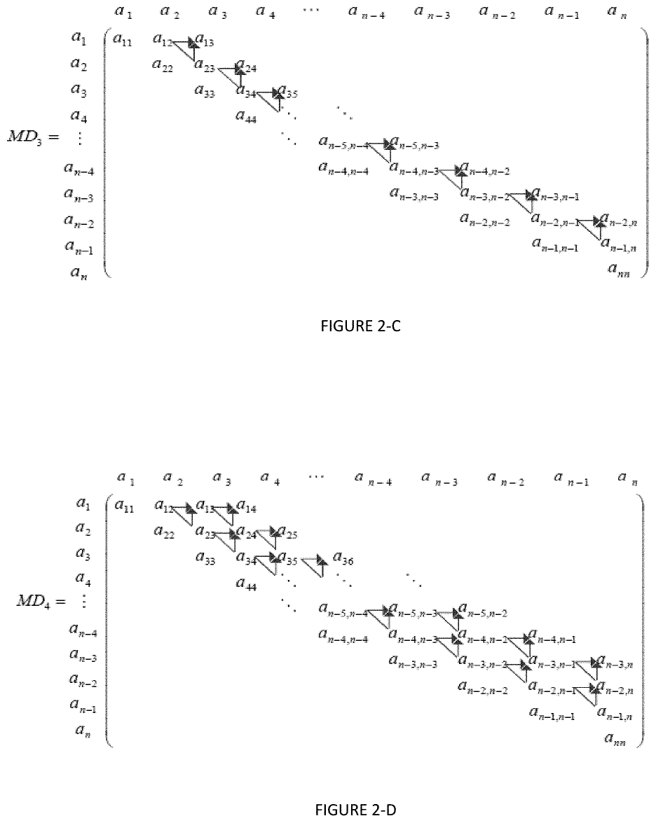

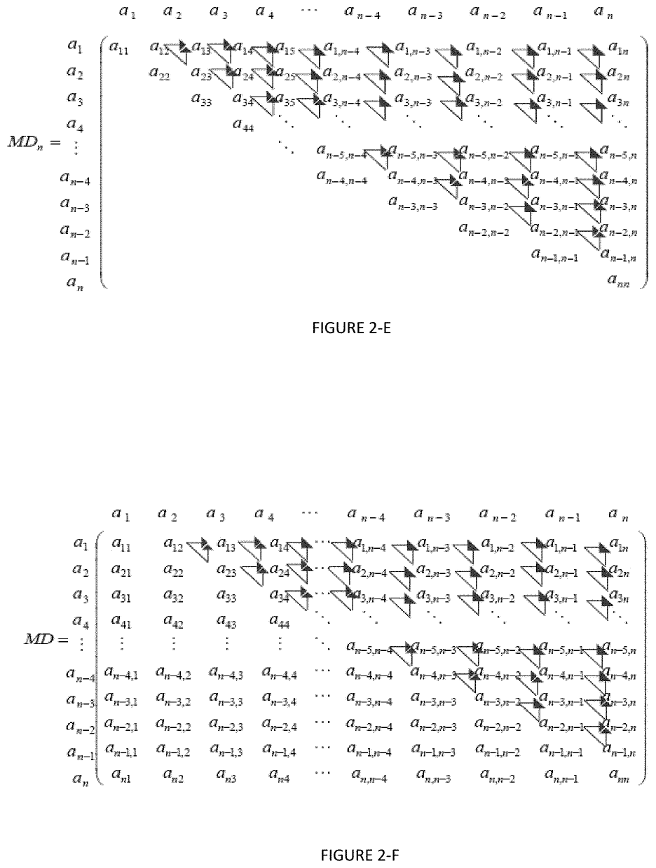

FIG. 2 illustrates a process performed by a behavior verification system for measuring a degree of user behavior consistency, according to certain embodiments of the present disclosure. Specifically, the process may include three stages 210, 220, and 230, which may be performed by the modules 151, 153, and 155 of the behavior verification system in FIG. 1, respectively. In some embodiments, the three stages 210, 220, and 230 may be performed sequentially or simultaneously/in parallel.

At the first stage 210, the behavior verification system may analyze the complex correspondence relation characteristics according to a user behavior model. At the second stage 220, the behavior verification system may establish a behavior profile according to user behavior characteristics, and may establish user behavior relation matrixes. At the third stage 230, the behavior verification system may complete user behavior matrix decomposition according to the complex correspondence characteristics of a user behavior, calculate a user behavior consistency measurement based on the user behaviors and expected behaviors.

In some embodiments, the behavior verification system may perform the first stage 210 via one or more implementation operations 211, 213 and 215. The behavior verification system may first convert user behavior data and/or expected behavior data into a set of workflow nets (e.g., workflow nets 212, 214, and 216). Each “workflow net” may be a special type of petri net that is suitable for expressing workflows. In other words, the behavior verification system may convert the user activities in the behavior data into workflows that contain multiple states and actions representative of these user activities.

In some embodiments, in operation 211, the behavior verification system may subdivide/identify cross-order relations based on the workflow nets 212, 214, and 216, and refine these behavior relations as behavior profile relations. In operation 213, the behavior verification system may analyze dependency relations in the workflow nets according to transactions in the user activities. Further, in operation 215, the behavior verification system may analyze complex correspondence relations, classify these complex correspondence relations into categories, and determine behavior characteristics of each of the categories. In some embodiments, the behavior verification system may perform the operations 211, 213, and 215 in parallel.

In some embodiments, the behavior verification system may perform the second stage 220 via multiple implementation operations 221, 223, 225, and 227. Specifically, in operation 221, the behavior verification system may establish user-extended behavior profile relations based on the behavior profile relations refined in operation 211. In operation 223, the behavior verification system may convert behavior relations into matrix elements based on operation 221 in combination with operation 213, according to a formula as shown below:

$${a}_{ij} \{ \begin{matrix}2 & {a}_{i} + {a}_{j} \\ 1 & \\ {0}_{0} & \\ {0}_{1} & \\ {0}_{2} & \\ {0}_{3} & \\ - 1 & \end{matrix}$$

in which i, j=1, 2, . . . , n; and aᵢⱼ denotes the elements in the behavior relation matrixs.

In operation 225, the behavior verification system may establish one or more user behavior relation matrix graphs based on operations 221 and 223. Specifically, the behavior verification system may establish the matrix graph based on an exemplary matrix flow: MD₁→MD₂→MD₃→MD₄ . . . →MDn→MD. FIG. 2-A may illustrate an exemplary matrix MD₁; FIG. 2-B may illustrate an exemplary matrix MD₂; FIG. 2-C may illustrate an exemplary matrix MD₃; FIG. 2-D may illustrate an exemplary matrix MD₄; FIG. 2-E may illustrate an exemplary matrix MDn; and FIG. 2-F may illustrate an exemplary matrix MD.

In operation 227, the behavior verification system may identify multiple classes of correspondence relations from the complex correspondence relations provided by operation 215, and determine correlations among these classes of correspondence relations based on behavior characteristics of each of the classes. Specifically, the classes of correspondence relations may be determined based on soundness, liveness, and boundedness of the wokflow nets.

In some embodiments, the behavior verification system may perform the third stage 230 via multiple specific implementation operations 231 and 233. Specifically, in operation 231, the behavior verification system may decompose user behavior relation matrixes according to the multiple classes of complex correspondence relations determined in operation 227 and the behavior relation matrix graph established in operation 225. In operation 233, the behavior verification system may calculate behavior consistency measurement between a user model and an expected model according to correspondence relations between the user model and the expected model.

In some embodiments, the behavior verification system may perform the operation 233 to calculate behavior consistency measurement based on an exemplary calculation formula as shown below:

$$Consistency Measurement = \frac{Area of consistent behavior relation in matrixes}{Total area of behavior relation matrixes}$$

wherein “area of consistent behavior relation in matrixes” refers to the area of consistent portions of user activities in the matrixes, and “total area of behavior matrixes” refers to the total area in the matrixes which covering the entire behavior relations. Thus, a higher behavior consistency measurement value may represent that user behaviors and expected behaviors are more consistent, a lower behavior consistency measurement value represents that the user behavior and the expected behaviors are less consistent, and when behavior consistency measurement is particularly low, the user behaviors may be suspected as being fraudulence or illegal.

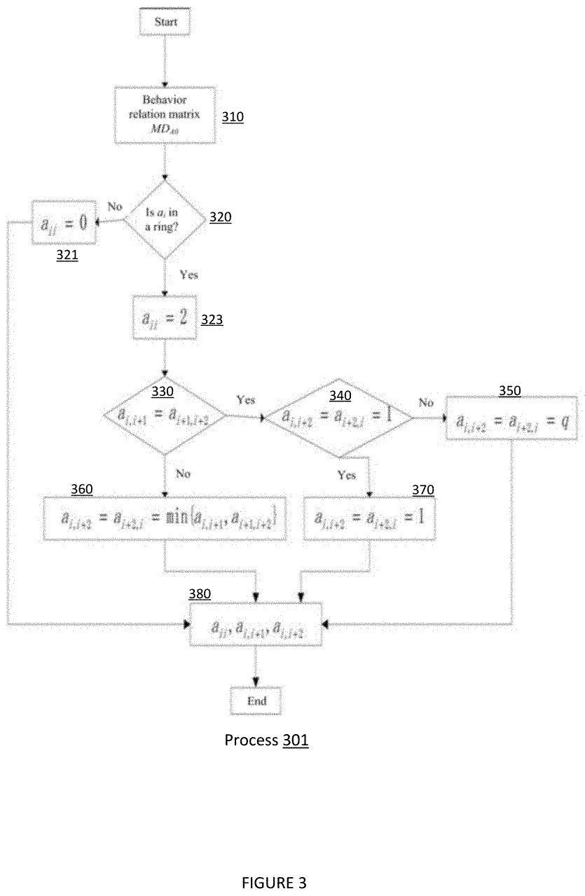

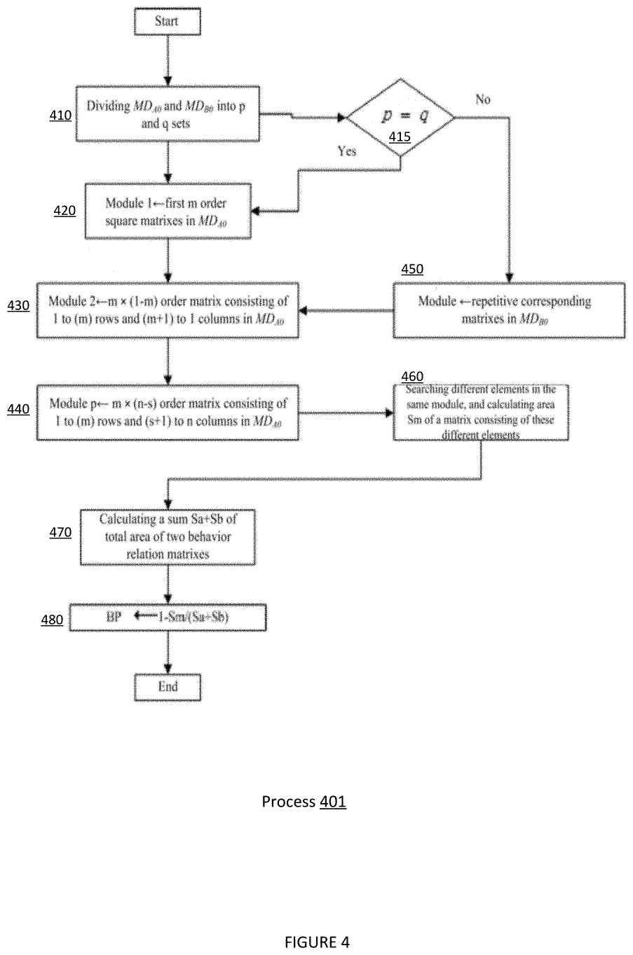

In some embodiments, the behavior verification system may perform the second stage 220 and third stage 230 to find a solution from the behavior relation matrix graph. Specifically, the behavior verification system may perform the second stage 220 and third stage 230 based on processes as illustrated in FIG. 3 and FIG. 4, respectively.

FIG. 3 illustrates a process 301 to generate behavior relation matrix and behavior relation matrix graph, according to certain embodiments of the present disclosure. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. Moreover, one or more of the outlined steps and operations may be performed in parallel.

In the process 301 of FIG. 3, the behavior verification system may receive two workflow nets N1 and N2 as inputs. The workflow nets N1 and N2 may be defined as N1=(P1, T1; F1) and N2=(P21, T2; F2), where they have transition sets of correspondence relations:

A={a₁, a₂, . . . , aₙ}; B={b₁, b₂, . . . , bₙ};

aᵢⱼ={0|aᵢ∥_{\tilde{→}}aⱼ} ∨ {1|(aᵢ\tilde{→}aⱼ) ∨ (aᵢ\tilde{→}⁻¹aⱼ)} ∨ {2|(aᵢ30 aⱼ)} ∨ {3|aᵢ∥₊aⱼ} (i=1, 2, . . . , n)

bᵢⱼ={0|bᵢ∥_{\tilde{→}}bⱼ} ∨ {1|(bᵢ\tilde{→}ⱼb) ∨ (bᵢ\tilde{→}⁻¹bⱼ)} ∨ {2|(bᵢ+bⱼ)} ∨ {3|bᵢ∥₊bⱼ} (i=1, 2, . . . , m)

The behavior verification system may perform the process 301 to generate behavior relation matrixes MD_{A0} and MD_{B0}; based on the workflow nets N1 and N2, and may further generate, for output, behavior relation matrix graphs MD_{A} and MD_{B} with elements aᵢⱼ(i,j=1, 2, . . . , n) and bᵢⱼ (i,j=1, 2, . . . , m) respectively.

In operation 310, the behavior verification system may first select one of the behavior relation matrixes MD_{A0} and MD_{B0}; for generating matrix elements contained therein. In operation 320, the behavior verification system may identify the diagonal elements aᵢᵢ (i=1, 2, . . . , n) in the behavior relation matrix MD_{A0}, and sequentially process each of the diagonal elements in the matrix, in order to determine whether aᵢᵢ (i=1, 2, . . . , n) may form a ring structure or not. If the behavior verification system determines that element aᵢᵢ is in a ring structure, the process 301 may assign aᵢᵢ=2 (operation 323), and move to operation 330. Otherwise, the process 301 may assign aᵢᵢ=0 (operation 321), and move to operation 380.

In some embodiments, at operation 330, the behavior verification system may compare the values of a_{i,j+1} and a_{i+1,i} (i=1, 2, . . . , n−1) that are associated with the workflow net N₁, convert the behavior relation between the a_{i,j+1} and a_{i+1,i} into an integer p, and output a_{i,i+1}=a_{i+1,i}=p. Afterward, the behavior verification system may compare the values of a_{i,i+2} and a_{i+2,i} (i=1, 2, . . . , n−2). If a_{i,i+1}≠a_{i+1,i+2}, the behavior verification system may proceed to operation 360 to generate an output a_{i,i+2}=a_{i+2,i}=min{a_{i,j+1},a_{i+1,i+2}}. Otherwise, the behavior verification system may proceed to operation 340.

In some embodiments, at operation 340, the behavior verification system may compare the values of a_{i,i+1} and a_{i+1,i+2}. If a_{i,i+1}=a_{i+1,i+2}=1, the behavior verification system may proceed to operation 370 to generate an output a_{i,i+2}=a_{i+2,i}=1. If a_{i,i+1}=a_{i+1,i+2}≠1, the behavior verification system may proceed to operation 350. At operation 350, the behavior verification system may evaluate the behavior relations between aᵢ and aᵢ₊₂, convert the behavior relations into a relation value q, and generate an output a_{i,i+2}=a_{i+2,i}=q. Afterward, the behavior verification system may proceed to operation 380.

In some embodiments, at operation 380, the behavior verification system may evaluate the values a_{i,i+h} and a_{i+h,i} (i=1, 2, . . . , n−h) (h=3, . . . , n−1), and generate an output a_{i,i+h}=a_{i+h,i}. The behavior verification system may complete process 301 once all the diagonal elements in the workflow net N1 are processed. Similarly, the behavior verification system may process the workflow net N2, output values for elements bᵢⱼ (i,j=1, 2, . . . , m) in MD_{B}, and generate a matrix MD_{B} based on similar operations in the process 301.

FIG. 4 illustrated a process 401 to obtain a behavior consistency measurement, according to certain embodiments of the present disclosure. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. Moreover, one or more of the outlined steps and operations may be performed in parallel.

In some embodiments, the behavior verification system may implement its third stage 230 based on the process 401. Specifically, the process 401 may receive, as inputs, two workflow nets N₁=(P₁, T₁; F₁) and N₂=(P2₁, T₂; F₂), as well as two behavior relation matrixes MD_{A0} and MD_{B0} that are generated by the process 301. The process 401 may generate a behavior consistency measurement BP as output.

In some embodiments, at operation 410, the behavior verification system may divide matrixes MD_{A0} and MD_{B0} into p and q, based on the correspondence relations in the MD_{A0} and MD_{B0}, The behavior verification system may also sequentially mark the MD_{A0} as {a₁, a₂, . . . , aₘ}, {aₘ₊₁, aₘ₊₂, . . . , a₁} . . . {aₛ₊₁, . . . , aₙ}. Afterward, the process 401 may proceed to operation 420.

In some embodiments, at operation 420, the behavior verification system may mark the first m order of matrix in MD_{A0} as a module 1, based on a first set {a₁, a₂, . . . , aₘ} in MD_{A0} and corresponding to MD_{B0}. Afterward, the process 401 may proceed to operation 430.

In some embodiments, at operation 430, the behavior verification system may mark an m×(1−m) order of matrix, which may include 1→(m) rows and (m+1)→(1) columns of data in MD_{A0} as a module 2, based on a second set {aₘ₊₁, aₘ₊₂, . . . , a₁} in MD_{A0} and corresponding to MD_{B0}, Afterward, the process 401 may proceed to operation 440.

In some embodiments, at operation 440, the behavior verification system may mark an m×(n−s) order of matrix, which may include 1→(m) rows and (s+1)→(n) columns of data in MD_{A0}, as a module p, based on a pth set {aₛ₊₁, . . . , aₙ} in MD_{A0} and corresponding to MD_{B0}.

In some embodiments, at operation 440, the behavior verification system may further mark an (1−m) order of matrix, which may include (m+1)→(1) rows and (m+1)→(1) columns of data in MD_{A0}, as a module p+1, based on the second set {aₘ₊₁, aₘ₊₂, . . . , a₁} in MD_{A0} and corresponding to MD_{B0}.

In some embodiments, at operation 440, the behavior verification system may further mark an (1−m) order of matrix, which may include (m+1)→(1) rows and (m+1)→(1) columns of data in MD_{A0}, as a module p+1, based on the second set {aₘ₊₁, aₘ₊₂, . . . , a₁} in MD_{A0} and corresponding to MD_{B0}. Likewise, the behavior verification system may mark a (1−m)×(n−s) order of matrix, which may include (m+1)→(1) rows and (s+1)→(n) columns of data in MD_{A0}, as a module p+2. Thus, the behavior verification system may repeatedly perform similar operations by marking a (n−s) order of matrix, which may include s+1→n rows and s+1→n columns of data in MD_{A0}, as a module

$$\frac{p ( p + 1 )}{2} .$$

Afterward, the process 401 may proceed to operation 460.

In some embodiments, if at operation 410, p=q, the behavior verification system may perform a decomposing of MD_{B0} into

$$\frac{p ( p + 1 )}{2}$$

corresponding modules, and marking the modules as module 1, 2, . . .

$$\frac{p ( p + 1 )}{2} ,$$

similar to the above-described decomposing of MD_{A0}. Alternatively, if p≠q, the behavior verification system may decompose the non-repetitive correspondence relations in MD_{B0} into

$$\frac{p ( p + 1 )}{2}$$

corresponding modules, and proceed to operation 450.

In some embodiments, at operation 450, the behavior verification system may lock/identify repetitive corresponding transition sets, and sequentially mark the areas containing of the repetitive corresponding sets as module

$$\frac{p ( p + 1 )}{2} + 1 = {1}_{c} , \frac{p ( p + 1 )}{2} + 2 = {2}_{c} … , \frac{p ( p + 1 )}{2} + ( q - p ) = {( q - p )}_{c} ,$$

Afterward, the behavior verification system may proceed to operation 460.

In some embodiments, at operation 460, the behavior verification system may sequentially check matrix elements in module 1, 2, . . .

$$\frac{p ( p + 1 )}{2}$$

in MD_{A0}, find out aᵢ, aᵢ and different elements bᵢ, bⱼ in the same module of MD_{B0}, if p=q, at operations 470 and 480, the behavior verification system may outputting a consistency measurement BP, and ending the process 401. Otherwise, if p≠q, the behavior verification system may lock/identify module 1_{c}, 2_{c}, . . . , (q−p)_{c}, output a consistency measurement BP, and ending the process 401.

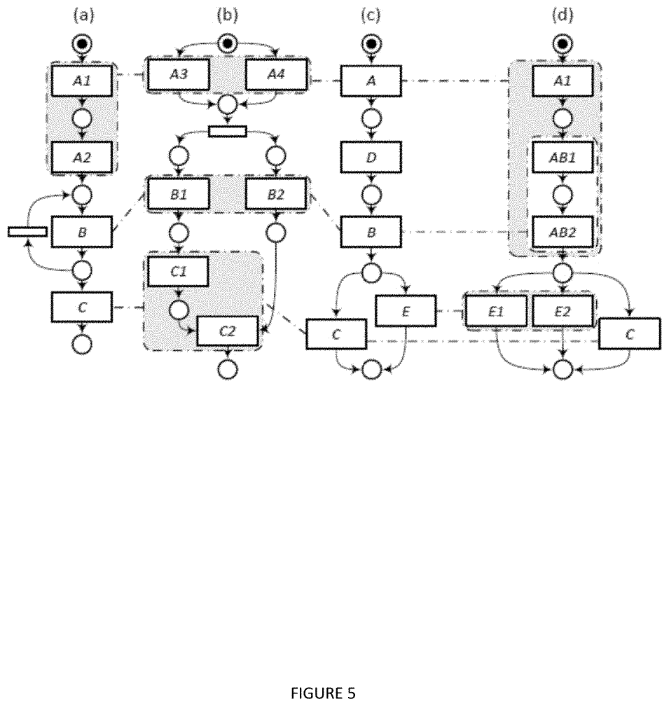

FIG. 5 illustrated an exemplary list of workflow nets, according to certain embodiments of the present disclosure. Specifically, FIG. 5 shows four workflow nets denoted as (a), (b), (c) and (d), which may be generate by the behavior verification system based on analysis of behavior relations in behavior data.

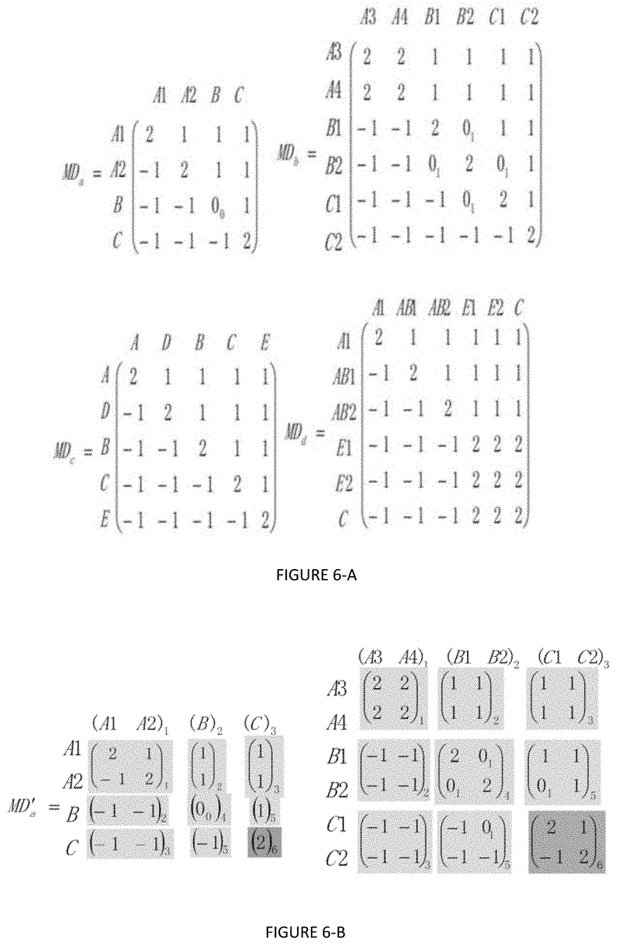

FIG. 6-A illustrates an exemplary list of behavior relation matrix graphs, according to certain embodiments of the present disclosure. Specifically, FIG. 6-A shows four behavior relation matrixes MDₐ, MD_{b}, MD_{c} and MD_{d} that are associated with four workflow nets (a), (b), (c) and (d), respectively.

FIG. 6-B illustrates an exemplary list of decomposed behavior relation matrix graphs, according to certain embodiments of the present disclosure. In some embodiments, the behavior verification system may perform a decomposition operation (similar to the operation 231 of FIG. 2) by using MDₐ and MD_{b} as an example. Afterward, the behavior verification system may perform a consistency measurement establishment operation (similar to the operation 233 of FIG. 2) to calculate a consistency measurement between (a) and (b) (i.e., MDₐ and MD_{b.}) using the follow process:

$${BP}_{≃} = 1 - \frac{{\sum }_{{a}_{i} {a}_{j} \neq {b}_{i} {b}_{j}} ( {S}_{{a}_{i} {a}_{j}} + {S}_{{b}_{i} {b}_{j}} )}{{S}_{{a}_{1} {a}_{n}} + {S}_{{b}_{1} {b}_{m}}} = 1 - \frac{\begin{matrix}( 1 \times 2 + 1 \times 1 + 1 \times 1 + 1 \times 1 ) + \\ ( 1 \times 1 + 1 \times 2 + 1 \times 2 + 1 \times 2 )\end{matrix}}{4 \times 4 + 6 \times 6} = 1 - \frac{13}{52} = 0.75 ;$$

In some embodiments, the behavior verification system may perform similar decomposition and consistency measurement calculation operations between (c) and (d) (i.e., MD_{d} and MD_{d.}), and obtain a consistency measurement of:

$$1 - \frac{( 1 \times 2 + 1 \times 2 + 1 \times 2 ) + ( 1 \times 1 + 1 \times 1 + 1 \times 1 )}{6 \times 6 + 3 \times 3} = 0.8 ;$$

In some embodiments, and in (c) and (d) in FIG. 5, when A˜{A1, AB1, AB2}, B˜{AB1, AB2}, the behavior verification system may calculate a consistency measurement between (c) and (d) is as follow:

$$1 - \frac{( 1 \times 1 + 1 \times 1 ) + ( 1 \times 2 + 3 \times 2 )}{6 \times 6 + 3 \times 3} = \frac{42}{52} \approx 0.81 .$$

In view of the above calculations, a consistency measurement between a user behavior (a) and a user behavior (b) as shown in FIG. 5 may reach 75%, a consistency measurement between a user behavior (b) and a user behavior (c) may reach 80%, and a consistency measurement between a user behavior (c) and a user behavior (d) may reaches 81%. Thus, all of these consistency measurements are comparatively high, indicating that the user behaviors should be consistent with the expected behaviors.

Thus, systems and methods for performing behavior consistency verification have been disclosed. The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments of the disclosure may be useful machine operations. In addition, one or more embodiments of the disclosure also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present disclosure may be implemented as one or more computer programs or as one or more computer program modules embodied in one or more computer readable media. The term non-transitory computer readable storage medium refers to any data storage device that can store data which can thereafter be input to a computer system. Computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present disclosure have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

In addition, while described virtualization methods have generally assumed that virtual machines present interfaces consistent with a particular hardware system, persons of ordinary skill in the art will recognize that the methods described may be used in conjunction with virtualizations that do not correspond directly to any particular hardware system. Virtualization systems in accordance with the various embodiments, implemented as hosted embodiments, non-hosted embodiments, or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Many variations, modifications, additions, and improvements are possible, regardless of the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A method configured for performing behavior consistency verification, the method comprising:
receiving, by a behavior verification system operating based on a physical hardware system, user behavior data containing user activities performed during electronic transactions;
retrieving, by the behavior verification system, expected behavior data corresponding to the user behavior data;
generating, by the behavior verification system, a behavior consistency measurement based on the user behavior data and the expected behavior data; and
transmitting, by the behavior verification system, the behavior consistency measurement in response to the receiving of the user behavior data, wherein the behavior consistency measurement indicates a degree of consistency between the user behavior data and the expected behavior data.

2. The method as recited in claim 1, wherein the generating of the behavior consistency measurement comprises:
converting the user behavior data and the expected behavior data into workflow nets;
extracting behavior relations based on the workflow nets;
generating behavior relation matrixes and behavior relation matrix graphs based on the behavior relations; and
generating the behavior consistency measurement based on the behavior relation matrixes and behavior relation matrix graphs.

3. The method as recited in claim 2, wherein the extracting of the behavior relations based on the workflow nets comprises:
identifying cross-order relations in the workflow nets; and
refining the cross-order relations as behavior profile relations.

4. The method as recited in claim 3, wherein the generating of the behavior relation matrixes and the behavior relation matrix graphs comprises:
establishing extended behavior profile relations from the behavior profile relations.

5. The method as recited in claim 4, wherein the extracting of the behavior relations based on the workflow nets comprises:
analyzing dependency relations in the workflow nets.

6. The method as recited in claim 5, wherein the generating of the behavior relation matrixes and the behavior relation matrix graphs comprises:
generating elements for the behavior relation matrixes based on the dependency relations and the extended behavior profile relations.

7. The method as recited in claim 2, wherein the extracting of the behavior relations based on the workflow nets comprises:
analyzing complex correspondence relations in the workflow nets.

8. The method as recited in claim 7, wherein the generating of the behavior relation matrixes and the behavior relation matrix graphs comprises:
classifying the complex correspondence relationships into multiple classes.

9. The method as recited in claim 8, wherein the generating of the behavior consistency measurement comprises:
decomposing the behavior relation matrix graphs based on the classified multiple classes.

10. The method as recited in claim 9, wherein the generating of the behavior consistency measurement further comprises:
calculating the behavior consistency measurement based on area of consistency behavior relation in the behavior relation matrixes and total area of the behavior relation matrix.

11. A non-transitory computer-readable storage medium, containing a set of instructions which, when executed by a processor, cause the processor to perform a method for performing behavior consistency verification, the method comprising:
receiving, by a behavior verification system operating based on a physical hardware system, user behavior data containing user activities performed during electronic transactions;
retrieving, by the behavior verification system, expected behavior data corresponding to the user behavior data;
generating, by the behavior verification system, a behavior consistency measurement based on the user behavior data and the expected behavior data; and
transmitting, by the behavior verification system, the behavior consistency measurement in response to the receiving of the user behavior data, wherein the behavior consistency measurement indicates a degree of consistency between the user behavior data and the expected behavior data.

12. The non-transitory computer-readable storage medium as recited in claim 11, wherein the generating of the behavior consistency measurement comprises:
converting the user behavior data and the expected behavior data into workflow nets;
extracting behavior relations based on the workflow nets;
generating behavior relation matrixes and behavior relation matrix graphs based on the behavior relations; and
generating the behavior consistency measurement based on the behavior relation matrixes and the behavior relation matrix graphs.

13. The non-transitory computer-readable storage medium as recited in claim 12, wherein the extracting of the behavior relations based on the workflow nets comprises:
identifying cross-order relations in the workflow nets;
refining the cross-order relations as behavior profile relations;
analyzing dependency relations in the workflow nets; and
analyzing complex correspondence relations in the workflow nets.

14. The non-transitory computer-readable storage medium as recited in claim 13, wherein the generating of the behavior relation matrixes and the behavior relation matrix graphs comprises:
establishing extended behavior profile relations from the behavior profile relations;
generating elements for the behavior relation matrixes based on the dependency relations and the extended behavior profile relations; and
classifying the complex correspondence relationships into multiple classes.

15. The non-transitory computer-readable storage medium as recited in claim 14, wherein the generating of the behavior consistency measurement comprises:
decomposing the behavior relation matrix graphs based on the classified multiple classes; and
calculating the behavior consistency measurement based on area of consistency behavior relation in the behavior relation matrixes and total area of the behavior relation matrixs.

16. A system configured for performing behavior consistency verification, the system comprises:
a behavior consistency evaluation module for receiving user behavior data containing user activities performed during electronic transactions;
an expected user behavior repository for storing expected behavior data corresponding to the user behavior data; and
a complex correspondence analysis module coupled with the behavior consistency evaluation module and the expected user behavior repository, wherein the complex correspondence analysis module generates a behavior consistency measurement based on the user behavior data and the expected behavior data, wherein the behavior consistency measurement indicates a degree of consistency between the user behavior data and the expected behavior data.

17. The system as recited in claim 16, wherein the complex correspondence analysis module generates the behavior consistency measurement by:
converting the user behavior data and the expected behavior data into workflow nets;
extracting behavior relations based on the workflow nets;
generating behavior relation matrixes and behavior relation matrix graphs based on the behavior relations; and
generating the behavior consistency measurement based on the behavior relation matrixes and the behavior relation matrix graphs.

18. The system as recited in claim 17, wherein the extracting of the behavior relations based on the workflow nets comprises:
identifying cross-order relations in the workflow nets;
refining the cross-order relations as behavior profile relations;
analyzing dependency relations in the workflow nets; and
analyzing complex correspondence relations in the workflow nets.

19. The system as recited in claim 18, wherein the generating of the behavior relation matrixes and the behavior relation matrix graphs comprises:
establishing extended behavior profile relations from the behavior profile relations;
generating elements for the behavior relation matrixes based on the dependency relations and the extended behavior profile relations; and
classifying the complex correspondence relationships into multiple classes.

20. The system as recited in claim 19, wherein the generating of the behavior consistency measurement comprises:
decomposing the behavior relation matrix graphs based on the classified multiple classes; and
calculating the behavior consistency measurement based on area of consistency behavior relation in the behavior relation matrixes and total area of the behavior relation matrixs.
